(19) United States
(12) Patent Application Publication
(10) Pub. No.: US 2001/0033285 A1
(43) Pub. Date: Oct. 25, 2001

(54) Character attribute setting device and method in document preparing apparatus

(76) Inventor: Hideyuki Okuno, Kawasaki (JP)

Correspondence Address: STAAS & HALSEY LLP, 700 11TH STREET, NW, SUITE 500, WASHINGTON, DC, 20001, US

(21) Appl. No.: 09/725,274

(22) Filed: Nov. 29, 2000

(30) Foreign Application Priority Data
Dec. 3, 1999 (JP) 11-344225

(51) Int. Cl. G06T 11/00

(52) U.S. Cl. 345/467

(57) ABSTRACT

If the color of a character is modified, for example, from “black” to “blue”, “ [symbol] ” is inputted and a conversion key is pressed. In this case, although “ [symbol] ”etc., is displayed as in usual kana/kanji conversion, “ [symbol] ” is displayed in blue if “ [symbol] ” is also set as a control code. If this is selected, “ [symbol] ” inputted before is recognized to be a control code instructing to set the color of characters to “blue”, the character stringy “ [symbol] ” is deleted and subsequent inputted characters are displayed in blue. If a color printer is used, the characters which are displayed in blue can be printed in blue.

### BACKGROUND OF THE INVENTION

1. Field of the Invention

The present invention relates to a device and method for setting the character attribute of a character in a document in a personal computer, word processor and other electronic equipment.

2. Description of the Related Art

With the spread of personal computers and word processors, today a great number of people prepare a document with a personal computer or word processor and print the document with a printer, etc. In these situations, a more friendly document preparation function is demanded. In particular, in the prior art, a character attribute is usually modified by displaying a menu screen and selecting a desired character attribute from the menu.

Characters other than alphabets used in the following description are Japanese kanji, katakana or hiragana.

FIG. 1 shows a conventional method of designating a character color of a document in preparation.

When a document writer designates the color of a character, in this example, the color is designated by using a menu.

First, the document writer inputs an arbitrary document 100 and then displays a color selection screen 101. The document writer selects a desired color from a displayed color menu on the color selection screen and modifies the color of inputted character.

FIGS. 2 and 3 show the process of control codes which is executed in a Japanese word processor manufactured by Fujitsu (hereinafter called an “OASYS (trademark)” word processor).

A control character is a character having a character code made to control a print result (font/code) other than a normal character font (kanji, kana and alphabet). In an OASYS word processor, a control character can be inputted from a keyboard. For example, if you want to input a character in Mincho style, you are first requested to input “ [symbol] ” from a keyboard, to hold down the conversion key and to output a control key. Then, characters inputted following this control code are specified to be printed in Mincho style at the time of print out and are actually printed in Mincho style. In this way, in an OASYS word processor, the modification of a character attribute at the time of printout can be implemented by inputting the reading method of a control code from a keyboard.

FIG. 2 is a flowchart showing the analysis procedure of a print control code on the document editing screen of a word processor.

In FIG. 2, an italicized character is used as an example of a character attribute. In FIG. 2, each character in a line is inspected, and the process flow is branched and a different process is executed based on whether a character code corresponding to a control code can be found.

Specifically, first, in step S110, the character code of the n-th line (n is a positive number) is obtained. Then, in step S111, the number of characters in the line is obtained. In step S112, a character counter, an italic flag and italic type information are initialized. In step S113, it is judged whether the analysis of all characters of the n-th line is completed. If the analysis is not completed, in step S114 one character is obtained. Then, in step S115, it is judged whether the obtained character is an italic control code. If the character is an italic control code, the flow proceeds to step S117. In step S117, a subsequent character is further obtained and in step S118, it is judged whether the designation of an italic style is valid. For example, it is judged whether the character code is one of 0 to 3. If the designation of an italic type is not valid, the flow proceeds to step S120. If the designation of an italic type is valid, the flow proceeds to step S119, and in step S119, it is judged whether the character code is one of 1 to 3. If the character code is one of 1 to 3, in step S123 the italic flag is set to “1” and simultaneously the italic type information is also set, Then, in step S124, the character counter for indicating the number of characters which are currently processed is incremented by one and the flow proceeds to step S122. In step S122, the character counter is also incremented by one. The reason that the character counter is incremented by two is that in step S115 a control code is recognized and a character following the control code is also processed. After step S122, the update of the character counter is completed, the flow returns to step S113 and it is judged whether the analysis of all characters is completed.

If in step S115 it is judged that the character obtained in step S114 is not a control code, the flow proceeds to step S120 and the character code is stored in a one-line character code storage buffer. The flow also proceeds to step S121 and the italic type information is set in a one-line extension information buffer and the flow proceeds to step S122.

If in step S155 it is judged that the character obtained in step S114 is a control code and if in step S118 it is judged that the italic type designation of the subsequent character obtained in step S117 is not valid, the flow proceeds to step S120. If in step S118 it is judged that the italic type designation is valid and if in step S119 the character code is not one of “1” to “3”, the flow proceeds to step S125, the italic flag is set to “0”, the italic type information is set to “0” and the flow proceeds to step S124.

If it is judged that the analysis of all characters is completed when the flow returns from step S122 to step S113, it is judged that both the analysis of one line and the assembly of a character code are completed and the flow proceeds to the process of a subsequent line.

FIG. 3 shows how to store the data in steps S120 and S121 in the flowchart shown in FIG. 2.

A character code storage area is a place to store analyzed character codes and sequentially stores the character codes from the first character of analysis. The number of extension information storage area is the same as the number of character attributes which can be set, and in FIG. 3 the italic information is stored in an extension information storage area 1. Extension information is configured to be extended if information about one character is added by the addition of a control code, etc. Actually, since the extension information is defined in units of bits, information about a plurality of control codes is stored in one extension information area and the storage area is extended if the area is filled up.

In this way, each character code is related to a storage position in the storage area and the extension information of a character attribute, etc., provided to each character code is stored in the respective storage area.

In the OASYS word processor described above, a kana reading (for example, “ [symbol] ”) is inputted from a keyboard, a control code is displayed in a document by pressing the kana/kanji conversion key and if subsequent characters are printed, printout according to the control code is available. For the input method of the control code of an OASYS word processor, see the operation manual of a Japanese OASYS word processor manufactured by Fujitsu.

As technologies to easily input a character attribute, there are several publicly well-known technologies.

For example, Japanese Patent Laid-open No. 1-150968 discloses the technology to select and set a character attribute using a menu as described above.

Japanese Patent Laid-open No. 8-292953 discloses a technology to register characters in a user dictionary together with the attribute and to select a character having a desired character attribute when a kana with a specific kana reading is converted into a kanji.

Japanese Patent Laid-open No. 6-28436 discloses a technology to color a graphic based on an inputted color reading by inputting a color reading when the color of a graphic is set.

Japanese Patent Laid-open No. 9-128524 discloses a technology to modify and display the color of illustrations as designated, by inputting a color reading from a word processor, etc.

Japanese Patent Laid-open No. 7-244662 discloses a technology to designate many attributes using only a few operation keys by assigning in advance a plurality of attribute contents to one operation key.

When designating character color using a menu as in the Japanese Patent Laid-open No. 1-150968 or FIG. 1, an operator must call up the menu and select a proper character color, in other words at least two actions are required: (1) the call-up of a menu and (2) the selection of a character color. When calling up the menu with a menu key, etc., the operator must release his/her finger from the home position of a keyboard and thereby the operation is temporarily stopped. When a menu reading key is assigned to the combination of the Ctrl key and an arbitrary key, the operator must remember the assigned key and thereby an extra load is placed on the operator.

Even when a plurality of attributes are assigned to a specific operation key as in the Japanese Patent Laid-open No. 7-244662, the operator must remember the assigned key as in the case a menu reading key is operated.

According to the Japanese Patent Laid-open No. 6-28436 or 9-128524, the color of illustrations can be designated. However, if it is taken into consideration the fact that today a variety of presentation documents can be prepared by a word processor, etc., it is preferable that not only the color of illustrations, but the attributes, such as color, font, etc., of input characters can be designated.

According to the Japanese Patent Laid-open No. 8-292953, the operator can input a character with a variety of attributes without moving his/her finger from the home position. However, a character which is not registered in a user dictionary and an attribute cannot be combined. Therefore, if you want to combine a new character with an attribute, you have to newly register the combination, which is a problem. Since too many combinations of a character and an attribute must be registered, an enormous amount of memory is required to enable efficient document preparation, which is another problem.

Although in an OASYS word processor, character attributes can be designated from the home position, this is available only at the time of printout, and a control code is displayed on the word processor screen without modification. In this case, the position of a character actually printed is shifted by a control code from a character position displayed on the word processor screen or set color cannot be displayed. Therefore, the operator cannot anticipate when a document will be completed, which is another problem.

### SUMMARY OF THE INVENTION

It is an object of the present invention to provide a document preparing apparatus and method having a function to set the attribute of an input character with a small memory capacity and without moving an operator's finger from the home position in order to solve the problems described above.

The character attribute setting control device of the present invention is a device for setting the character attributes described above in order to display characters inputted by an input means on a display means, and the device comprises a control unit for modifying the character attributes of the displayed character by using a specific character or character string including the definition of a natural language inputted by the input means at least in a part of it and deleting the inputted character or character string from the screen of the display means.

The device of the present invention comprises an input means, a display means for displaying a character inputted by an operator via the input means and a control means for inputting a specific character or character string including the definition of a natural language inputted by the input means at least in a part of it, modifying the character attributes of a displayed character and deleting the inputted character or character string from the screen of the display means.

The method of the present invention is a method in an apparatus with an input device and the method comprises the steps of displaying characters which are inputted by an operator via the input device, inputting a specific character or character string including the definition of a natural language which is inputted by the input means at least in a part of it and deleting the inputted character or character string from the screen in the display step.

According to the present invention, since an operator can designate a character attribute via an input device by inputting the content of the character attribute expressed in a natural language or a content close to it, it is not necessary for the operator to remember a method of inputting many control codes. Since the designation of a character attribute is deleted from the screen when the character attribute is modified, a long line of hard-to-remember codes on a display screen can be avoided. In particular, the appearance of a printed result can be matched with the appearance of a screen display by pairing data representing a character attribute with character code data for each character, storing both pieces of data and referring to the data at the time of printout or screen display.

### BRIEF DESCRIPTIONS OF THE DRAWINGS

FIG. 1 shows a conventional method of designating the character color of a document during preparation.

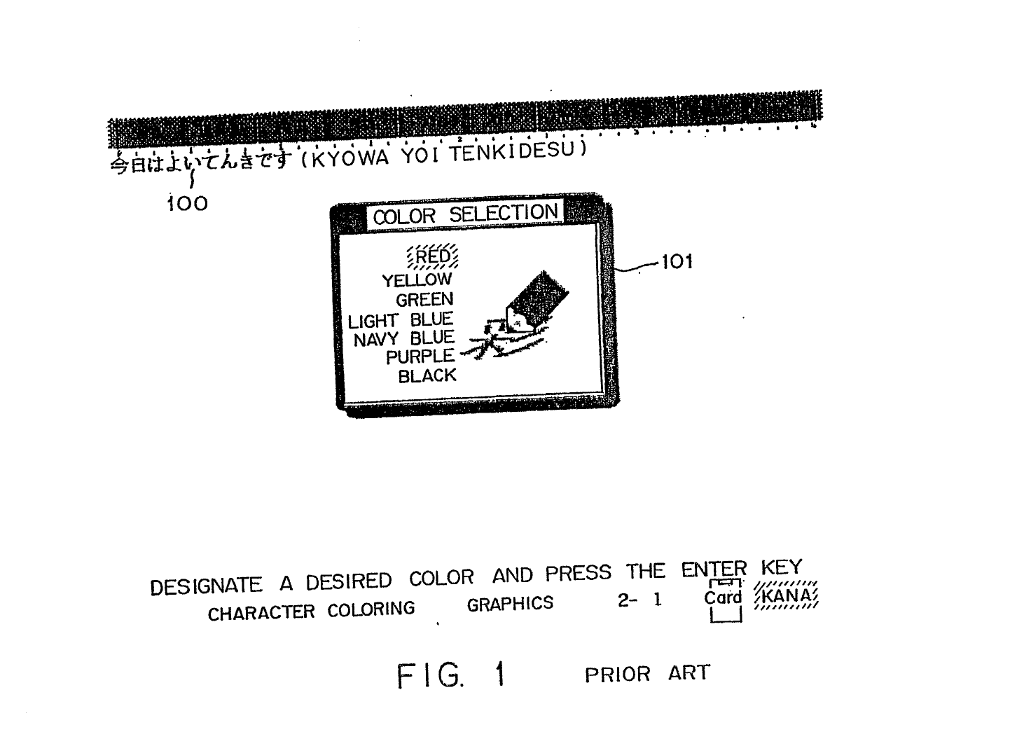

FIG. 2 shows the process of a control code executed in a Japanese word processor manufactured by Fujitsu (No. 1).

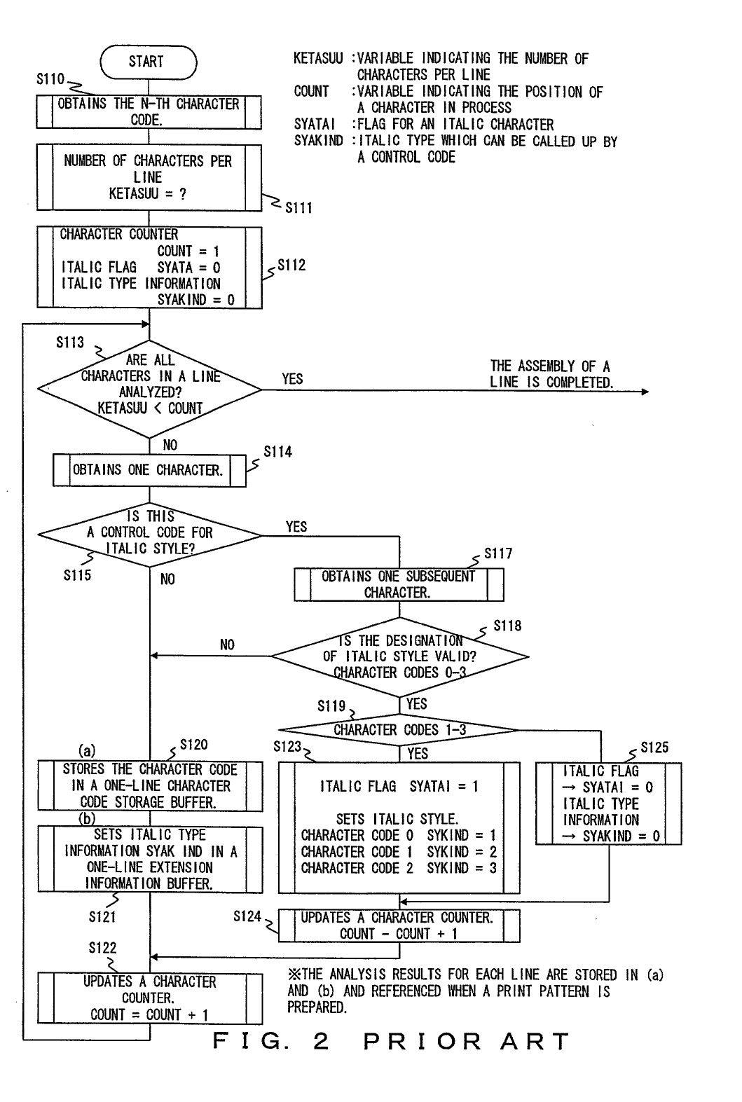

FIG. 3 shows the process of a control code executed in a Japanese word processor manufactured by Fujitsu (No. 2).

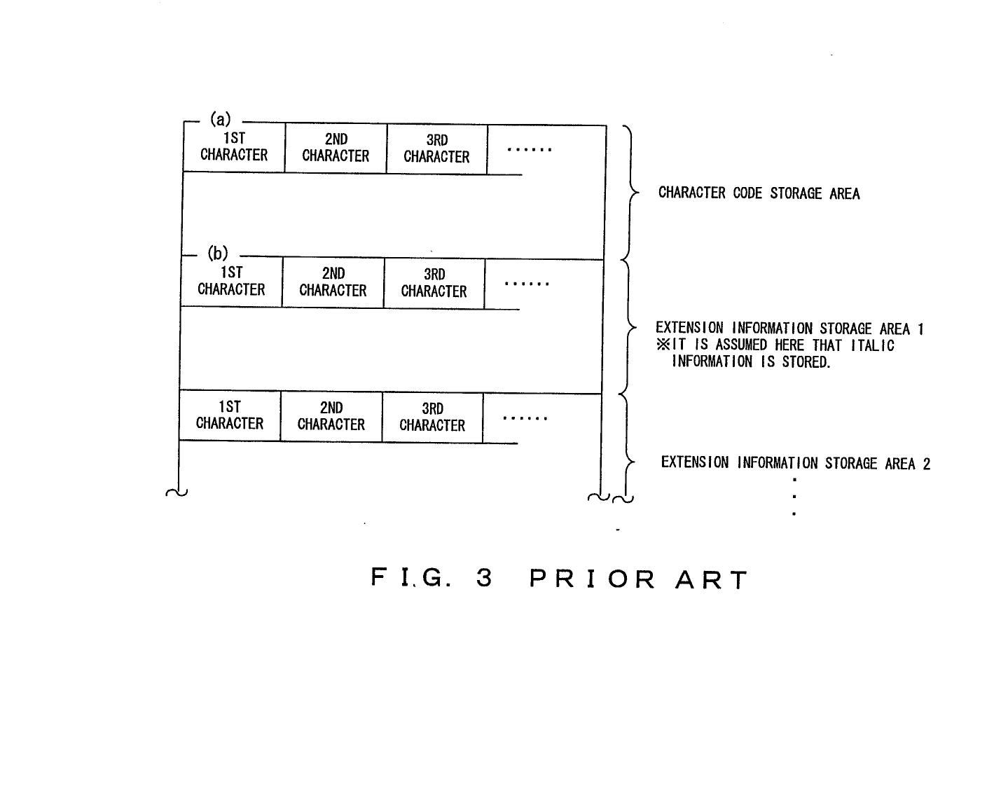

FIG. 4 shows the outline of the dictionary retrieval unit of a document preparing apparatus.

FIG. 5 shows the internal configuration of a CPU (central processing unit).

FIG. 6 is a flowchart showing the basic algorithm of a kana/kanji conversion function.

FIG. 7 is a flowchart showing the basic algorithm of this preferred embodiment.

FIGS. 8A and 8B show the memory structures of character code data and format information.

FIG. 9 is a flowchart showing a procedure of writing display data in a display device by software using format information.

FIG. 10 shows a conversion example of character color as a character attribute.

FIG. 11 shows a conversion example of character style, etc., as a character attribute.

FIG. 12 shows the preferred embodiment in a English word processor.

FIG. 13 shows examples of storage media.

### DESCRIPTION OF THE PREFERRED EMBODIMENTS

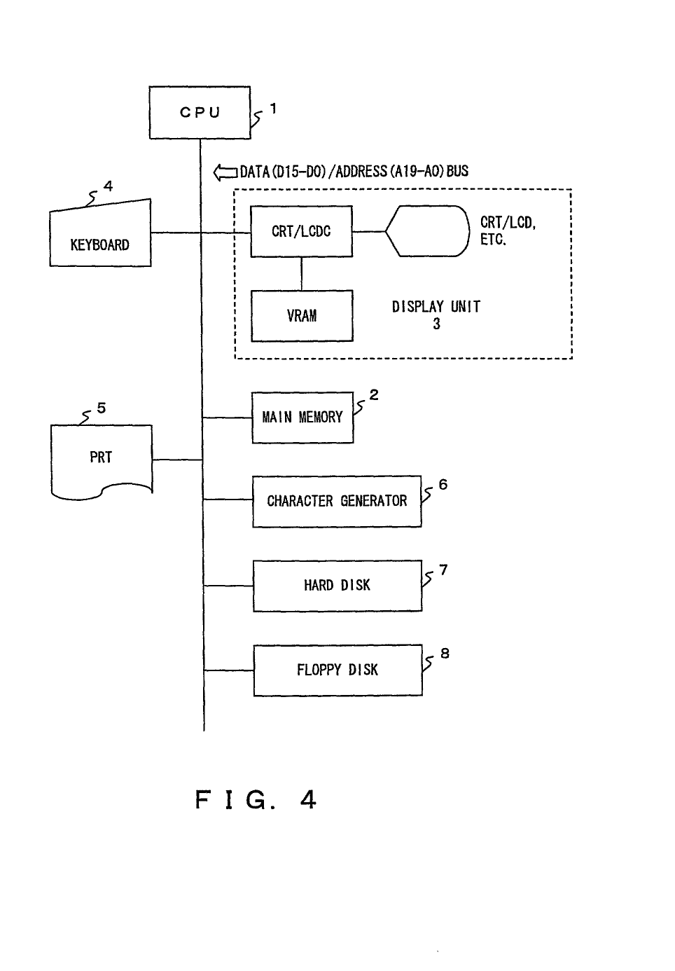

FIG. 4 shows the outline of the dictionary retrieval unit of the document preparing apparatus.

The dictionary retrieval unit of the document preparing apparatus of the present invention comprises a CPU 1, a main memory 2, a display 3, a keyboard 4, a printer 5, a character generator 6 and a hard disk 7. In FIG. 4, the keyboard 4 indicates a general input device and includes an input device by pen input, a soft keyboard, etc. After being interpreted by the CPU 1 via a data (D15-D0)/address (A19-A0) bus, a character code inputted from the keyboard 4 is stored in the main memory 2, and simultaneously the code is transmitted to the character generator 6 and is replaced with a character. Then, the output of the character generator 6 is transmitted to the CRT/LCD controller of the display 3, is composed into an image, is stored in a VRAM and simultaneously is displayed on the CRT/LCD. The characters displayed on a CRT/LCD, etc., are printed by the printer 5.

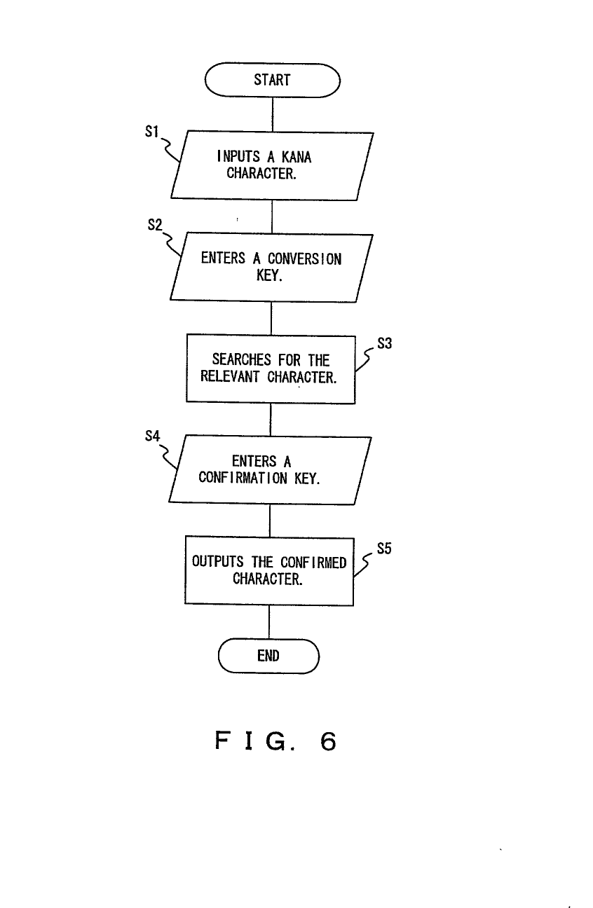

The hard disk 7 stores programs for executing the processes of the flowcharts shown in FIGS. 6, 7 and 8, which are described later. After being read into the main memory 2, these programs are executed by the CPU.

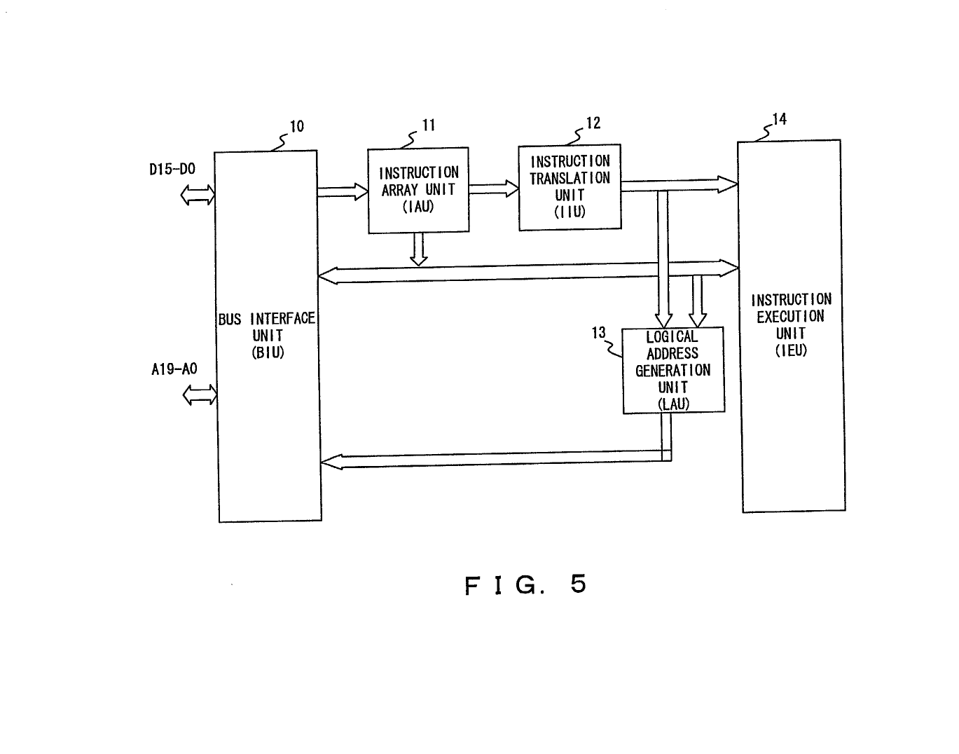

FIG. 5 shows the internal configuration of the CPU.

In FIG. 5, the CPU comprises five units: an instruction array unit 11, an instruction translation unit 12, an instruction execution unit 14 and a logical address generation unit 13 which accompanies the units 11, 12 and 14, and a bus/interface unit 10 which independently exercises system/bus control, etc. A data bus D15-D0 inputs operator's instructions from the keyboard to the instruction array unit 11 via the bus/interface unit 10. The instruction array unit 11 puts the array of inputted instructions in order and inputs the array to the instruction translation unit 12. The instruction translation unit 12 converts the inputted instruction array into data which can be interpreted by the instruction execution unit 14 and passes the data to the instruction execution unit 14. If an address is required to execute an instruction, the instruction translation unit 12 inputs an address to be used to execute the instruction to the logical address generation unit 13. The instruction execution unit 14 performs necessary operations, provides the calculated address to the logical address generation unit 13 and transmits the operation result data to the bus/interface unit 10. Then, the logical address generation unit 13 outputs a logical address and inputs the address to the bus/interface unit 10. The data and address inputted to the bus/interface unit 10 are outputted from the bus/interface unit 10 as data D15-D0 and address A19-A0, respectively.

FIG. 6 is a flowchart showing the basic algorithm of a program of a kana/kanji conversion function.

A kana character is inputted from a keyboard, etc., (step S1) and a corresponding character string is searched for in a kana/kanji conversion dictionary (step S3) when a conversion key is pressed (step S2) and a kanji, etc., is determined by pressing a subsequent character key or Enter key (step S4). Then, the determined character is outputted to a CRT, etc., (step S5) and the kana/kanji conversion process is terminated.

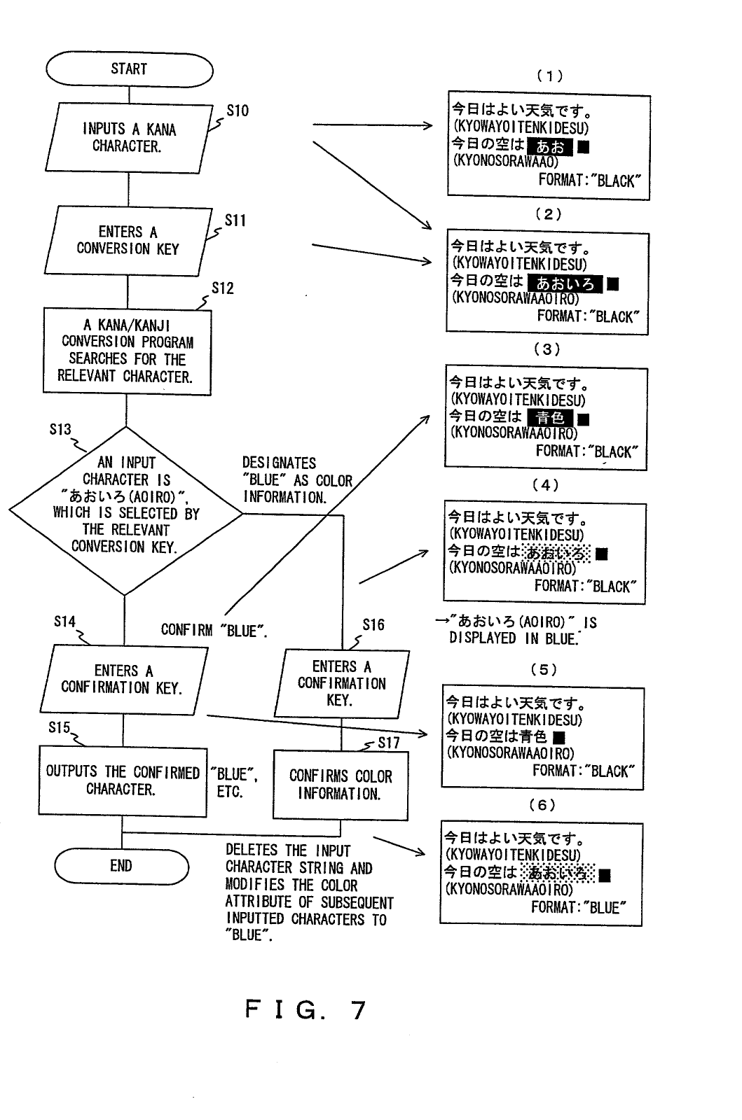

FIG. 7 is a flowchart showing the basic algorithm of a program of the preferred embodiment.

In FIG. 7, an example of modifying a character color attribute from “black” to “blue”, assuming that an input character string is “ [symbol] ”. In this example, a default character color is assumed to be “black”.

First, a kana character is inputted from a keyboard, etc. (step S10). For example, “ [symbol] ” is inputted, as shown in (1) and (2) on the right of FIG. 7. In this case, kana characters existing before conversion are displayed in reverse font. Then, when a conversion key is entered (step S11), a corresponding character string is searched for in the kana/kanji conversion dictionary.

If a character string “ [symbol] ” is searched for, conventionally, for example, a phrase “ [symbol] ” is outputted as a result, while in this preferred embodiment, a character attribute of a blue color corresponding to “ [symbol] ” is also outputted as a research result. In this case, whether a character output result of “ [symbol] ” or a character color attribute of a blue color is selected can be determined by the user. If in step S13 the character string “ [symbol] ” is selected (see (3) shown in FIG. 7), the character string of “ [symbol] ” remains (step S15, see (5) shown in FIG. 7) after the character is confirmed (step S14). If in step S13 the character color attribute of a blue color is selected (step S16, see (4) shown in FIG. 7), the character color attribute changes to blue (see (6) shown in FIG. 7) and the character string “ [symbol] ” is deleted. Then, the color information of input characters is set to blue (step S17) and the process is terminated.

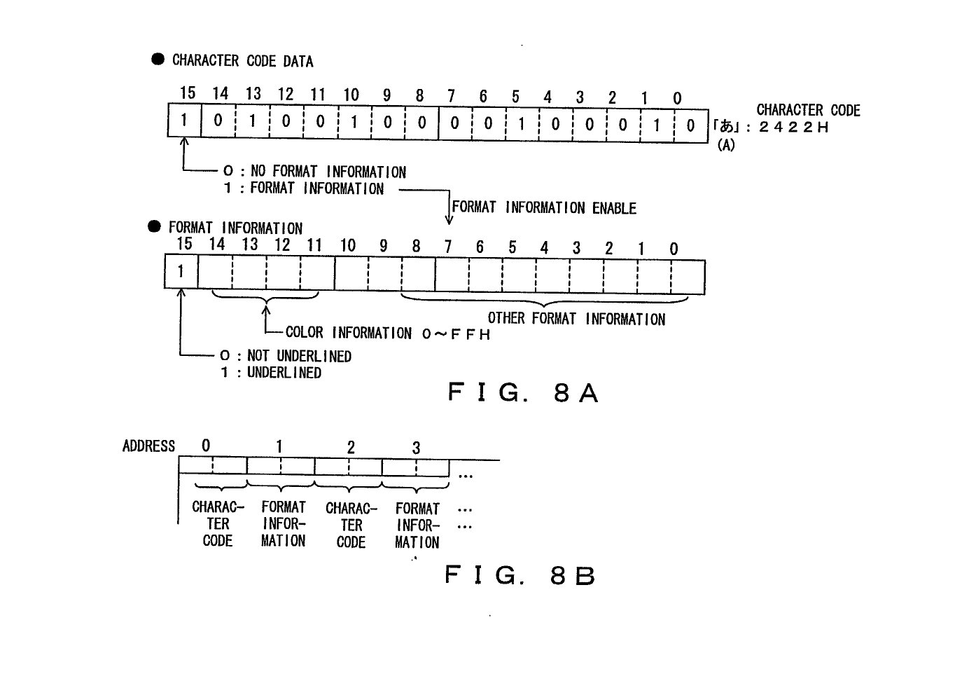

FIGS. 8A and 8B show the memory structures of both character code data and format information.

FIG. 8A shows a bit structure. In this preferred embodiment, two bytes each are assigned to both the character code data and format information. FIG. 8B shows a storage example of character code data, etc., in the main memory 2. In this preferred embodiment, a bit indicating whether there is format information is provided in the leftmost bit place of character code data for one character (in the case of FIG. 8, character code 2422H of “ [symbol] ”). Since this bit is not usually used, in this preferred embodiment, the bit is used, in particular to indicate the existence/non-existence of character format information. If format information is set in the leftmost bit of character code data, the format information of a character code is referenced. In the format information, a bit for indicating the existence/non-existence of an underline is provided in the leftmost bit, and color information is set in the subsequent four bits. Format information, such as font, etc., is set in the remaining bits.

In this way, as shown in FIG. 8B, character code data and format information which are provided for each character are arrayed in series in a pair of a character code and a piece of format information corresponding to the character code. Therefore, a character code and the format information are alternately arrayed. If a character is displayed on a CRT screen, etc., first, a character code is read, then the character is judged, and then the existence/non-existence of format information is judged. If there is format information, format information arrayed immediately after the character code is read and format which is set to a character corresponding to the read character code is specified, a prescribed format is set to the character and the character is displayed. If the character is printed by a printer, etc., both the character code and format information are read in the same way as the character is displayed on a CRT screen, etc., and the data are converted into data for a printer.

In this way, in this preferred embodiment, when the attribute of a character is set, the attribute can be set by inputting kana characters indicating the attribute, simultaneously both the structures of a character code and the format information different from an illustration can be provided, and a character attribute setting method in a word processor, personal computer, etc., can also be provided.

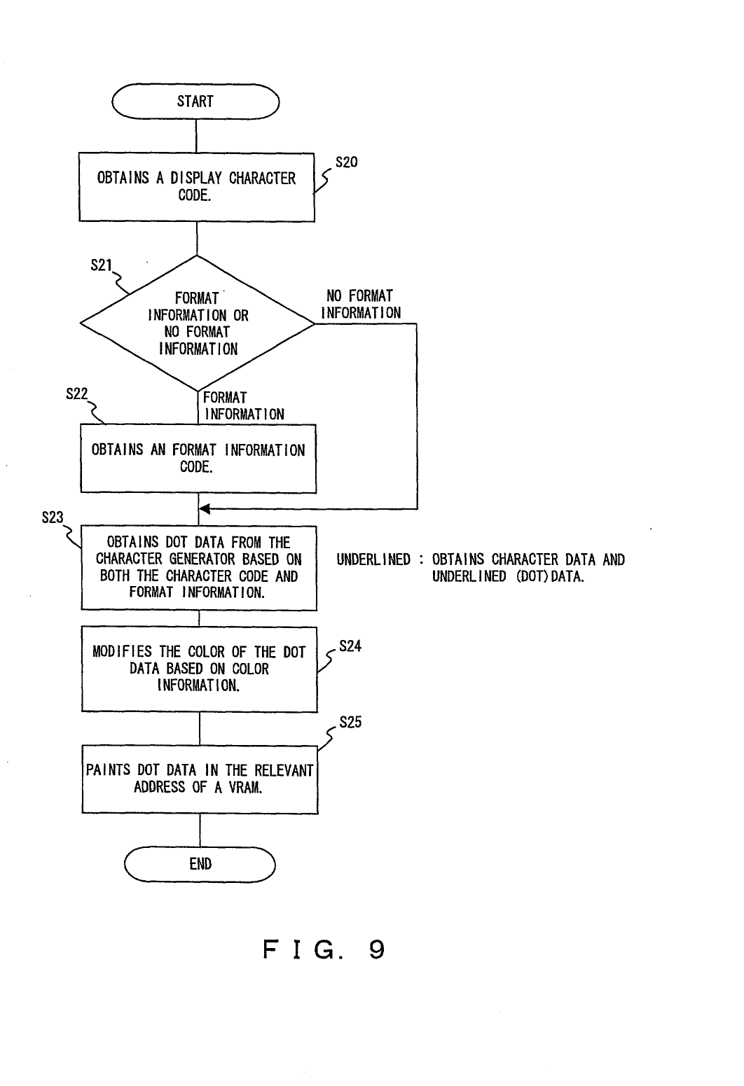

FIG. 9 is a flowchart showing a procedure of writing display data in a display device by software using character code data and format information.

As shown in FIG. 9, character code data which are stored in a memory in the formats shown in FIGS. 8A and 8B are inputted from the memory to a CPU (step S20). For example, FIG. 8A shows a state where “ [symbol] ” of “ [symbol] ” is stored in a memory. A character code 2422H is stored, in this example, in the lower-order 14 bits of a character code data storage area. Then, the existence/non-existence of format information is judged by the leftmost bit of the character code (the leftmost bit of a character code is usually fixed to “0”)(step S21). If there is format information, an format information code is obtained (step S22). If there is no format information, step S22 is skipped. FIG. 8B shows the storage state of format information. In this preferred embodiment, the left most bit of the format information is for underline information, bits 14 to 11 are for character color information and bits 10 to 0 are in reserve. Then, a display program obtains dot data from a character generator based on both a character code to be displayed and the format information (step S23). Then, the data are formatted by the format information (step S24). Lastly, the relevant dot data are stored in the relevant address of a VRAM (step S25).

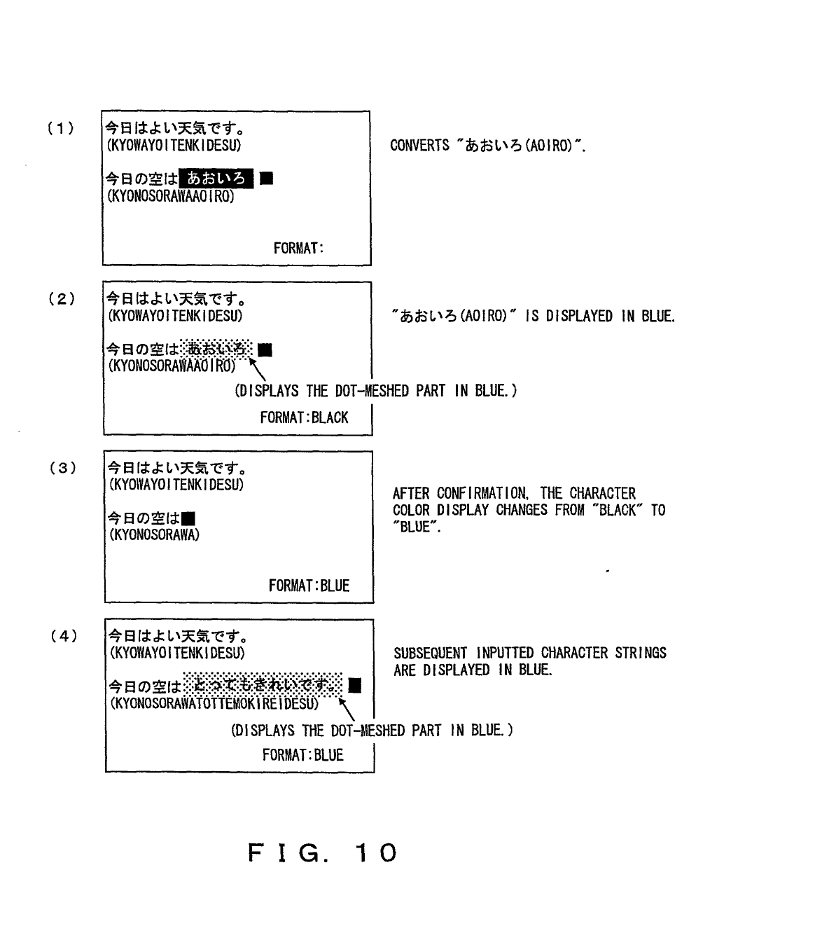

FIG. 10 shows a conversion example of character color as a character attribute.

This preferred embodiment is an application example of a character color conversion method using an input character in a Japanese word processor. However, the present invention is not limited only to a character color conversion, and is applicable to all character attributes which can be generally used in a word processor or personal computer.

FIG. 10(1) shows an example screen of a word processor, etc. This screen shows a state where “ [symbol] ” is inputted. “ [symbol] ” is unconfirmed character string. Although after this, every time a conversion key is inputted, “ [symbol] ”, “ [symbol] ”, etc. are displayed in that order, “ [symbol] ” is displayed in blue as one of the candidates (FIG. 10(2)). At this time, the format state indication at the bottom of the screen becomes “blue” by confirming the conversion result of “ [symbol] ” as the character attribute of the blue color, and the character string of “ [symbol] ” is deleted (FIG. 10 (3)). Characters to be subsequently inputted have a color attribute of “blue” and are displayed in blue on the screen (FIG. 10(4)).

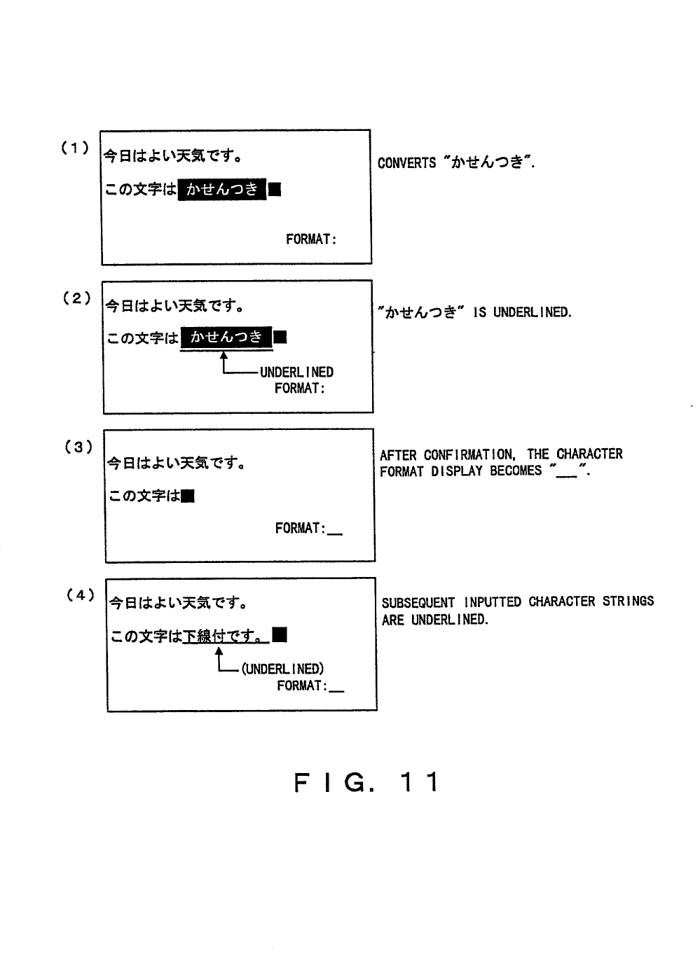

FIG. 11 shows a conversion example of a character style, etc., as a character attribute.

This preferred embodiment shows an application example of a character format conversion method using an input character in a Japanese word processor. In this example, an underlined character is described.

FIG. 11(1) shows an example screen of a word processor, etc. This screen shows a state where “ [symbol] is inputted. “ [symbol] ” is an unconfirmed character string. Although after this, every time a conversion key is inputted, “ [symbol] ”, “ [symbol] ”, etc., are displayed in that order, “ [symbol] ” is displayed as one of the candidates (FIG. 11(2)). At this time, the format state indication at the bottom of the screen becomes “_” by confirming the conversion result of “ [symbol] ” as the format attribute of the character and the character string of “ [symbol] ” is deleted (FIG. 11 (3)). Characters to be inputted after this have a color attribute of “underlined” and are displayed underlined on the screen (FIG. 11(4)).

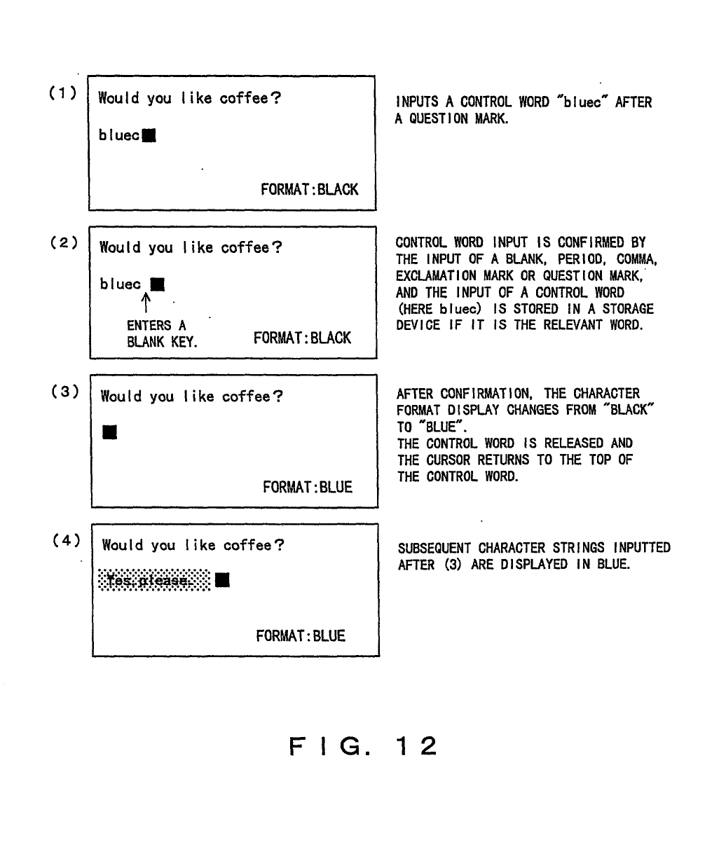

FIG. 12 shows the preferred embodiment in an English word processor.

As shown in FIG. 12A, in this preferred embodiment, a control word corresponding to the control code of a Japanese word processor is fixed (in this example, bluec; a combination of “blue” and “control”), and when a symbol for punctuating words, such as a blank, period, comma, exclamation mark, question mark, etc., after the control word is inputted, character color, font size, style of font, etc., are set.

In this preferred embodiment, a word of “bluec” which does not exist in English is set as a control word (FIG. 12(1)). If a control word is inputted and then a blank is inputted to punctuate words, the word processor program interprets “bluec” and modifies a character color to “blue”. The punctuation of words is recognized by a character which is used to punctuate as described above (FIG. 12(2)). If the word processor program recognized that a control word in inputted, in this preferred embodiment, character format display changes from “black” to “blue”, and the inputted control character is deleted (FIG. 12(3)). Then, character strings which are inputted after this operation become blue (FIG. 12(4)).

As described above, an operator can modify character attribute format information without moving his/her finger from the home position of a keyboard in a personal computer/word processor by applying this preferred embodiment. The operation is activated by the manipulation of a mechanism using a natural language and no command is added due to the addition of a function. Therefore, it is sufficient if only information indicating that a character attribute designating mechanism is added to a kana/kanji conversion mechanism in the case of a Japanese word processor, or a method, such as a control code automatic interpretation function, etc., is added in the case of an English word processor, is provided. Therefore, operation is simplified and the load for obtaining new information is reduced.

As shown in FIG. 10, an OASYS word processor is provided with both the screen/print character color modification system of a menu system and a print character color/font style/font size modification system. The former has a disadvantage that an operator cannot modify a screen character color without moving his/her finger from the home position, and the latter has a disadvantage that the printed result of a document is different from the display on a screen.

This preferred embodiment has an advantage that an operator can display a document without moving his/her finger from the home position or the display on the screen can be made to be a close approximation of the printed result by reducing the disadvantages described above.

In this preferred embodiment, a description has been given on the assumption that a kana/kanji conversion function is used in a Japanese word processor. However, if, for example, “ [symbol] ; [symbol] ” obtained by properly combining “ [symbol] ” and “ [symbol] ” indicating a control code, etc., is inputted as in the case of an English word processor, the system can also be configured in such a way that a character attribute can be modified without waiting for an operator's selection by kana/kanji conversion.

The system can also be configured in such a way that “ [symbol] ” is simply inputted instead of designating a specific color, such as “ [symbol] ”, etc., colors can be sequentially switched, for example, from red to blue, to yellow, to green, etc., every time a conversion key is pressed and the color can be confirmed when a desired color appears. In the same way, the system can be configured in such a way that “ [symbol] ” is simply inputted and a style can be switched to a different style every time a conversion key is pressed.

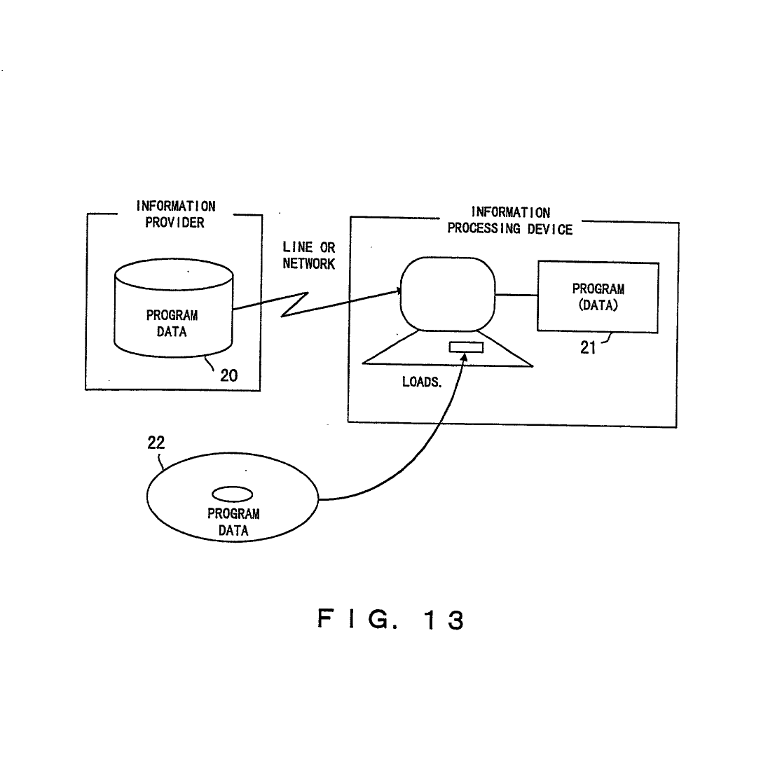

FIG. 13 shows examples of storage media.

If the method of this preferred embodiment is implemented using a program, an information processing device, such as a personal computer, a word processor, etc., stores program data 21 in a built-in memory device, such as a hard disk 7 and the program can be executed accordingly. Alternatively, program data 22 for implementing the process of this preferred embodiment can be read from a portable storage medium which stores the program data 22 and can be executed accordingly. For the portable storage medium, a floppy disk, a CR-ROM, a DVD, etc., are used, and if only the program of this preferred embodiment is distributed, the program can be stored and distributed in a portable storage medium. The hard disk of a computer in which a program is installed also corresponds to this storage medium. Although the program is temporarily stored in the main memory 2 of this preferred embodiment shown in FIG. 4 at the time of execution, such a memory in which the program is temporarily stored is also the storage medium of the present invention. The information processing device can also download and use, via a line, program data 20 which an information provider possesses. The program to implement the process of this preferred embodiment can also be downloaded and distributed via some communication means, such as a line, a network, the Internet, an intranet, a LAN, etc. Alternatively, the program to implement the process of the preferred embodiment can be executed in a network environment while the information processing device is connected with an information provider via the communication means described above. Such a situation can be easily implemented if a plurality of terminals are connected to a server via a LAN, etc.

The memory means for storing the program to be downloaded, such as a server connected to the communication means described above is also a storage medium. The state where a program is placed in a communication medium (carrier for communications) when the program is downloaded from the server, etc., is a kind of state where a program is stored in a storage medium.

If the function of the present invention is executed jointly with a plurality of programs, it constitutes a part of the present invention. The case where an operating system (or another application program) installed in advance in the computer and another program jointly implements the function of the present invention corresponds to this. This preferred embodiment includes a case where at least a part of the function which a program stored in a medium executes is a part of the function of the operating system described above or a part of another program. In the case of such a preferred embodiment, a program stored in a storage medium includes an instruction to call up the part of the function described above. Specifically, this preferred embodiment includes “a storage medium which records a program to be run in the computer system described above, and at least a part of the function described above is implemented by another program which operates in the computer system described above and the program recorded in the storage medium described above includes an instruction to call up the function which is implemented by the other program”.

According to the present invention, a bit is provided which relates format information to character code data and stores the format information and notifies the character code data of the existence/non-existence of format information. Therefore, even if arbitrary format information is set to a character code, a variety of format characters can be displayed and printed without an increase in the amount of data.

In particular, since character data are managed in units of character codes in a word processor unlike illustration data, character color, font, etc., can be easily set simply by relating the data to the format information.

Furthermore, an operator can set a variety of character attributes without moving his/her finger from the home position by inputting the character attributes on a screen using the name of the color or font representing a character attribute or a control word similar to the name, and simultaneously can set the character attributes by the input of a language close to a natural language. Therefore, an operator does not need extra knowledge about the key operation.

Since character code data are paired with format information and they are stored so that they relate to each other, characters can be displayed using the data when they are displayed on a screen. Therefore, an operator can not only see a character to which he/she has given a desired character attribute when it is printed, but can also edit a document while directly seeing how a character with a specific character attribute is actually arrayed.

What is claimed is:

1. A character attribute setting control device for setting a character attribute in order to display on a display device a character which is inputted by an input device, comprising
a control unit modifying a character attribute of the character to be displayed following input of a specific character or character string using the specific character or character string, including a definition by a natural language which is inputted by the input device at least in a part of it.

2. The character attribute setting control device according to claim 1, wherein
the character attribute is modified during a conversion in which an input character is converted to another character.

3. The character attribute setting control device according to claim 1, wherein
the character attribute is modified by selecting a candidate for a control symbol from a plurality of conversion candidates outputted in conversion where an input character is converted to another character.

4. The character attribute setting control device according to claim 1, wherein
the character attribute is modified during kana/kanji conversion.

5. The character attribute setting control device according to claim 1, wherein
the character attribute is modified by selecting a candidate which is indicated by a control code among a plurality of conversion candidates outputted in kana/kanji conversion.

6. The character attribute setting control device according to claim 1, wherein
the character or character string is composed of a word specifying the contents of both a character attribute as a natural language and a character indicating a control code.

7. The character attribute setting control device according to claim 4, wherein
the character or character string is composed of an English word and a specific alphabet.

8. The character attribute setting control device according to claim 4, wherein
data about the character attribute are stored paired with character code data representing a character for each character, the data are referenced when the character is printed and displayed, and an appearance of a printed character and an appearance of a character displayed on a screen are the same.

9. The character attribute setting control device
according to claim 1, wherein
said control unit modifies the character attribute and simultaneously deletes the inputted specific character or character string from a screen of a display device.

10. The character attribute setting control device according to claim 1, wherein
the character attribute is modified into another character attribute corresponding to a content of the specific character or character string.

11. An apparatus, comprising:
input means;
display means for displaying a character which an operator inputs via the input means; and
control means for inputting a specific character or character string, including a definition by a natural language in at least a part of it, which the operator inputs via the input means and modifying a character attribute of a character to be displayed following the input of the specific character or character string.

12. The apparatus according to claim 11, wherein the character attribute is modified during conversion when an input character is converted to another character.

13. The apparatus according to claim 11, wherein the character attribute is modified by selecting a candidate for a control symbol from a plurality of conversion candidates outputted in conversion where an input character is converted to another character.

14. The character attribute setting control device according to claim 11, wherein
said control unit modifies the character attribute and simultaneously deletes the inputted specific character or character string from a screen of a display means.

15. The character attribute setting control device according to claim 11, wherein
the character attribute is modified into another character attribute corresponding to a content of the specific character or character string.

16. The apparatus according to claim 11, wherein
the character attribute is modified during kana/kanji conversion.

17. The apparatus according to claim 11, wherein
the character attribute is modified by selecting a candidate which is indicated by a control code among a plurality of conversion candidates outputted in kana/kanji conversion.

18. The apparatus according to claim 11, wherein
the character or character string is composed of a word specifying the contents of a character attribute as a natural language and a character indicating a control code.

19. The apparatus according to claim 18, wherein
the character or character string is composed of an English word and a specific alphabet.

20. The apparatus according to claim 11, wherein
data about the character attribute are stored in pairs with character code data representing a character for each character, the data are referenced when the character is printed and displayed and an appearance of a printed character and an appearance of a character displayed on a screen are the same.

21. A method in an apparatus with an input device, comprising:
displaying a character which an operator inputs via the input device; and
inputting a specific character or character string, including a definition by a natural language at least in a part of it, which the operator inputs via the input device and modifying a character attribute of a character to be displayed following input of the specific character or character string.

22. The method according to claim 21, wherein
the inputted specific character or character string is deleted from a screen of a display device.

23. The method according to claim 22, wherein the character attribute is modified into another character attribute corresponding to a content of the specific character or character string.

24. A computer-readable storage medium on which is recorded a program for enabling a computer to execute a process, said process comprising the steps of:
displaying a character which an operator inputs via the input device; and
inputting a specific character or character string, including a definition by a natural language at least in a part of it, which the operator inputs via the input device and modifying a character attribute of a character to be displayed following input of the specific character or character string.

25. The computer-readable storage medium according to claim 24, wherein
the inputted specific character or character string is deleted from a screen of a display device.

26. The computer-readable storage medium according to claim 24, wherein
the character attribute is modified into another character attribute corresponding to a content of the specific character or character string.

27. A storage medium capable of being read by a computer system with an input device and a display device on which is recorded a program for enabling a computer to execute a process, said process comprising:
displaying a character which an operator inputs via the input device; and
modifying a character attribute of a character to be inputted and displayed following input of the specific character or character string using the specific character or character string, including a definition by a natural language, which is inputted by the input device at least in a part of it.

28. The storage medium according to claim 27, wherein
the inputted specific character or character string is deleted from a screen of a display device.

29. The storage medium according to claim 27, wherein
the character attribute is modified into another character attribute corresponding to a content of the specific character or character string.
